(19) United States
(12) Patent Application Publication
(10) Pub. No.: US 2022/0311733 A1
(43) Pub. Date: Sep. 29, 2022

(54) COMMUNICATION DEVICE AND COMMUNICATION SYSTEM

(71) Applicant: NEC Corporation, Tokyo (JP)

(72) Inventor: Koji KAWADA, Tokyo (JP)

(73) Assignee: NEC Corporation, Tokyo (JP)

(21) Appl. No.: 17/691,362

(22) Filed: Mar. 10, 2022

(30) Foreign Application Priority Data
Mar. 25, 2021 (JP) 2021-051941

(51) Int. Cl. H04L 61/5014; H04L 12/46

(52) U.S. Cl. CPC H04L 61/2015; H04L 12/4641

(57) ABSTRACT

In order to provide a communication device and a communication system that are capable of automating work for setting a management VLAN, the communication device includes: a communication unit that communicates with another communication device; and a management VLAN supervising unit that activates, when a link up state with the another communication device is detected, a management virtual local area network (VLAN) and sets the management VLAN for the communication unit.

This application is based upon and claims the benefit of priority from Japanese Patent Application No. 2021-51941, filed on Mar. 25, 2021, the disclosure of which is incorporated herein in its entirety by reference.

### TECHNICAL FIELD

The present invention relates to a communication device and a communication system, and more specifically relates to monitoring control of a communication device when a new communication device is installed for an existing communication device.

### BACKGROUND ART

Achievement of zero touch provisioning (ZTP) for capital expenditure reduction (CAPEX reduction) in a mobile backhaul network has been desired.

While ZTP is achieved by configuring a communication device (network element (NE)) through a data communication network (DCN) from a network management system (NMS), a software defined network (SDN) controller, or the like. However, it is necessary to manually conduct construction itself of a DCN.

In a corporate network and a network of a data center or the like, when a communication device is installed, an Internet protocol (IP) address (Internet is a registered trade mark) is delivered from a dynamic host configuration protocol (DHCP) server to the communication device, and the communication device acquires, via an IP network, firmware and a configuration file from a file transfer protocol (FTP) server or the like.

In contrast, in a mobile backhaul network, an NE is added in a multihop manner, and therefore there is no path for accessing the DHCP server. With expansion of mobile phone networks, transmission devices also increase and expand. Therefore, there is a problem that, with an increase of NEs, a DCN network necessary for monitoring control of these NEs is forcedly subjected to resetting (allocation of an IP address and division of a subnet). When the subnet is divided, it is necessary to simultaneously conduct work for modifying a configuration of a management virtual local area network (VLAN).

Japanese Translation of PCT International Application Publication No. 2015-513807 (JP2017-513807A) proposes, as a method for achieving ZTP, that an NE acquires an IP address from a dynamic host configuration protocol/domain name system (DHCP/DNS) server, and the NE acquires a configuration file from a server (network element manager (NEM)) that manages NEs.

International Publication No. WO2015/141186 relates to a setting method for performing communication between radio communication devices being connected via a radio link. International Publication No. WO2015/141186 proposes that setting information of an opposite radio communication device is received from the opposite radio communication device and thereby setting information relating to a local device is automatically generated.

However, the above-described communication systems as background arts produce the following problems.

In Japanese Translation of PCT International Application Publication No. 2015-513807, a newly-installed NE is assumed to be capable of accessing a DHCP server. Therefore, there is a problem that, in a mobile backhaul network, it is difficult to achieve ZTP.

In International Publication No. WO2015/141186, it is necessary to cause setting information to flow by using a frame. A default VLAN causes a frame other than a DCN to pass, and therefore there is a problem that it is difficult to construct a DCN, based on the default VLAN as is, and therefore a modification is always required later. International Publication No. WO2015/141186 does not relate to resetting of a DCN network necessary for monitoring control of a communication device and therefore remains in setting for performing communication among a plurality of radio communication devices newly installed.

An object of the present invention is to provide a communication device and a communication system that are capable of automating work for setting a management VLAN.

### SUMMARY

In order to achieve the object, a communication device according to the present invention includes:

a communication unit that communicates with another communication device; and

a management-virtual local area network (VLAN) management unit that activates, when a link up state with the another communication device is detected, a management VLAN and sets the management VLAN for the communication unit.

A communication system according to the present invention includes:

a network management system that manages one or a plurality of communication devices;

a dynamic host configuration protocol (DHCP) server that allocates an Internet protocol (IP) address to the one or the plurality of communication devices; and

the another communication device that communicates with above-mentioned communication device including the communication unit and the management VLAN supervising unit, is managed by the network management system, and is allocated with an IP address by the DHCP server.

According to the present invention, a communication device and a communication system that are capable of automating work for setting a management VLAN can be provided.

### BRIEF DESCRIPTION OF THE DRAWINGS

Exemplary features and advantages of the present invention will become apparent from the following detailed description when taken with the accompanying drawings in which:

FIG. 1 is a block diagram illustrating a communication device according to an example embodiment of a superior concept of the present invention;

FIG. 2 is a configuration diagram for illustrating a communication device and a communication system according to one example embodiment of the present invention;

FIG. 3 is a flowchart for illustrating automatic allocation processing for an IP address;

FIG. 4 is a flowchart for illustrating automatic setting processing for a management VLAN;

FIG. 5 is a configuration diagram for illustrating work for installing a newly-installed NE for an existing NE and setting a management VLAN;

FIG. 6 is a configuration diagram for illustrating work for further installing a newly-installed NE for an existing NE and setting a management VLAN; and

FIG. 7 is a sequence chart for illustrating a setting processing sequence among a newly-installed NE, a DHCP server, an NMS, and an existing NE.

### EXAMPLE EMBODIMENT

### [Outline of an Example Embodiment]

According to an example embodiment of the present invention, by using a function for automating work for setting a management virtual local area network (VLAN) for a port connected to a newly-installed network element (NE) and an existing NE, a VLAN network used for a data communication network (DCN) is constructed on an NE added in a multihop manner. Based on a setting automation function for a management VLAN, allocation and division of a subnet and reallocation of an Internet protocol (IP) address can be automatically executed according to the number of NEs, and thereby a DCN is automatically constructed.

Preferred example embodiments according to the present invention are described in detail with reference to the accompanying drawings.

### [Example Embodiment of a Superior Concept]

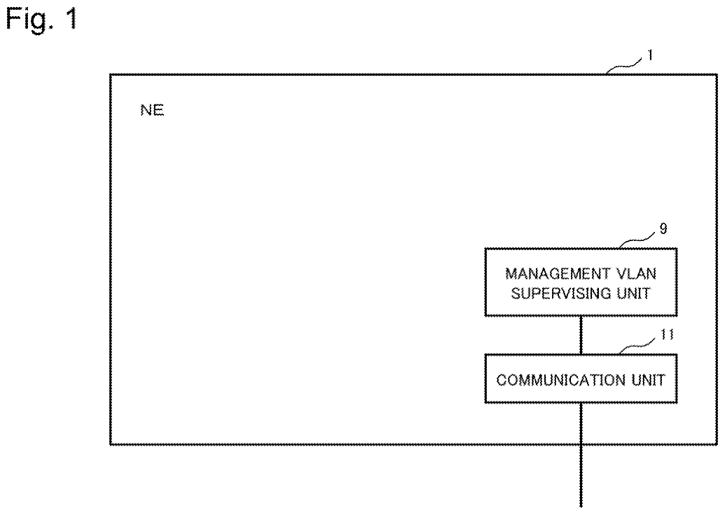

First, a communication device according to an example embodiment of a superior concept of the present invention is described. FIG. 1 is a block diagram illustrating a communication device according to an example embodiment of a superior concept of the present invention.

The communication device in FIG. 1 is a communication device (network element (NE)) as added to a mobile backhaul network in a multihop manner. The communication device (NE 1) in FIG. 1 includes a communication unit 11 that communicates with another communication device (NE) and a management-virtual local area network (VLAN) management unit 9 that activates, when link up with the another communication device (NE) is detected, a management VLAN and sets the management VLAN for the communication unit 11.

In the communication device (NE 1) in FIG. 1, when link up with another communication device (NE) is detected, a management VLAN is activated and the management VLAN is set for the communication unit 11. Thereafter, via another communication device (NE), a VLAN network used for a data communication network (DCN) is constructed on an NE added in a multihop manner. According to the communication device of the present example embodiment, work for setting a management VLAN can be automated.

Based on the setting of a management VLAN as a trigger, in a mobile backhaul network, addition of a communication device to a network management system and resetting of a DCN network necessary for monitoring control of a communication device including an added communication device can be automated. Hereinafter, a communication device and a communication system according to a specific example embodiment are described.

### [One Example Embodiment]

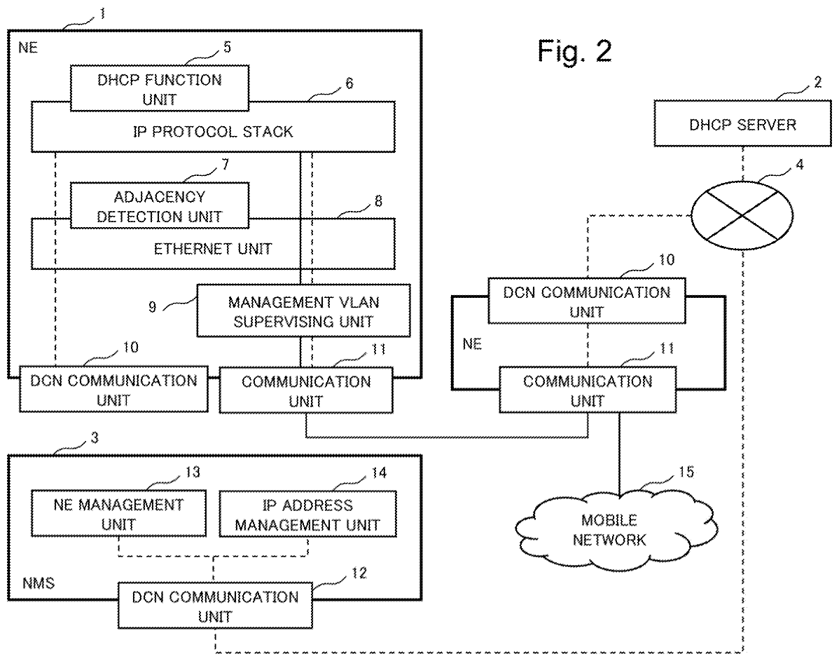

Next, a communication device and a communication system according to one example embodiment of the present invention are described. FIG. 2 is a configuration diagram of a communication system according to the one example embodiment of the present invention. In the communication system of FIG. 2, a data communication network (DCN) is illustrated with a dotted line, and a line causing communication data to flow is illustrated with a sold line. A difference between the present example embodiment and the background arts is a difference in processing for a management VLAN supervising unit 9 and an NE management unit 13. The communication system in FIG. 2 includes an NE 1, another NE connected to the NE 1, a hub 4, a DHCP server 2, a network management system (NMS) 3, and a mobile network 15. Herein, it is assumed that the another NE is an existing NE and the NE 1 is a newly-installed NE that is newly installed.

The NE 1 is a communication device, and includes a DCN communication unit 10 and a communication unit 11. The NE 1 further includes an IP protocol stack 6, an Ethernet unit 8 (“Ethernet” is a Registered Trademark), and a management VLAN supervising unit 9. The NE 1 is connected to another NE through the communication unit 11, is connected to the DHCP server 2 through the DCN communication unit 10, and is connected to the NMS 3 via the hub 4. It is assumed that the another NE connected to the NE 1 also includes a DCN communication unit 10 and a communication unit 11 and includes, while illustration of the following components is omitted, an IP protocol stack 6, an Ethernet unit 8, and a management VLAN supervising unit 9.

The IP protocol stack 6 is a module group including a function required for IP communication, such as management of an IP address and IP routing. The IP protocol stack 6 includes a DHCP function unit 5. The DHCP function unit 5 is a module for requesting an IP address from the DHCP server 2 and setting the received IP address for each bridge.

The Ethernet unit 8 includes an adjacency detection unit 7. The Ethernet unit 8 is a module group including a function required for Ethernet communication, such as management of a media access control (MAC) address of each of the DCN communication unit 10 and the communication unit 11 and frame transfer, and includes a function for detecting an adjacent NE by using a link layer discovery protocol (LLDP) and notifying the NMS 3 of the detected NE. The adjacency detection unit 7 extracts, from an LLDP message, information such as an IP address.

The management VLAN supervising unit 9 is a module including a function for setting a management VLAN for the communication unit 11, associating the communication unit 11 with the Ethernet unit 8, and causing data of a DCN flowing in the communication unit 11 to flow in the Ethernet unit 8.

The DCN communication unit 10 is an interface for performing communication via a DCN by being connected to the DHCP server 2 and the NMS 3.

The communication unit 11 is an interface for causing communication traffic to flow between NEs and transmits/receives DCN data via the management VLAN supervising unit 9.

The DHCP server 2 is a server including a DHCP (RFC2131) server function, and communicates with the NE 1 and the NMS 3 through a DCN.

The NMS 3 is a system for monitoring control of an NE and includes a DCN communication unit 12, an NE management unit 13, and an IP address management unit 14. The NMS 3 communicates with the NE 1 and the DHCP server 2 through a DCN. The DCN communication unit 12 is an interface for performing communication via a DCN by being connected to the DHCP server 2 and the NE 1. The NE management unit 13 is a program and a database that manage an NE subjected to monitoring control by the NMS 3 and registers/deletes, based on an IP address, an NE. The IP address management unit 14 is a program and a database and manages a network address to be monitored and the number of NEs of the address.

The hub 4 is a switch for connection among the NE 1, the DHCP server 2, and the NMS 3 or a router.

The mobile network 15 is a network including a base station, a core network, and the like.

### (Operation According to the Example Embodiment)

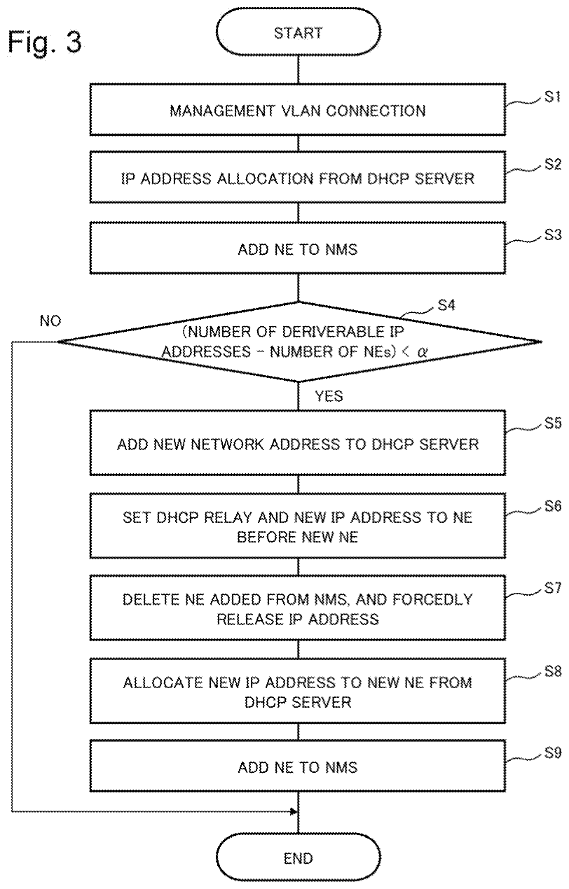

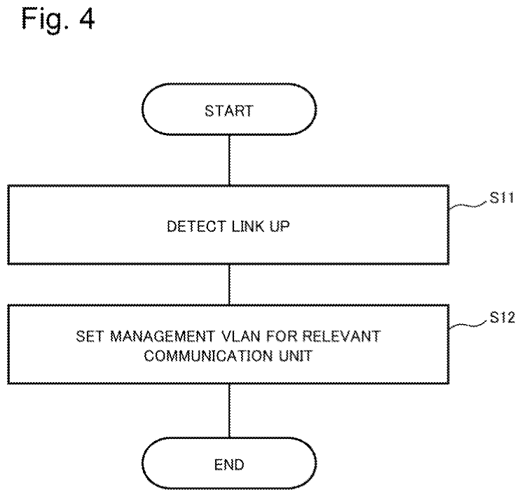

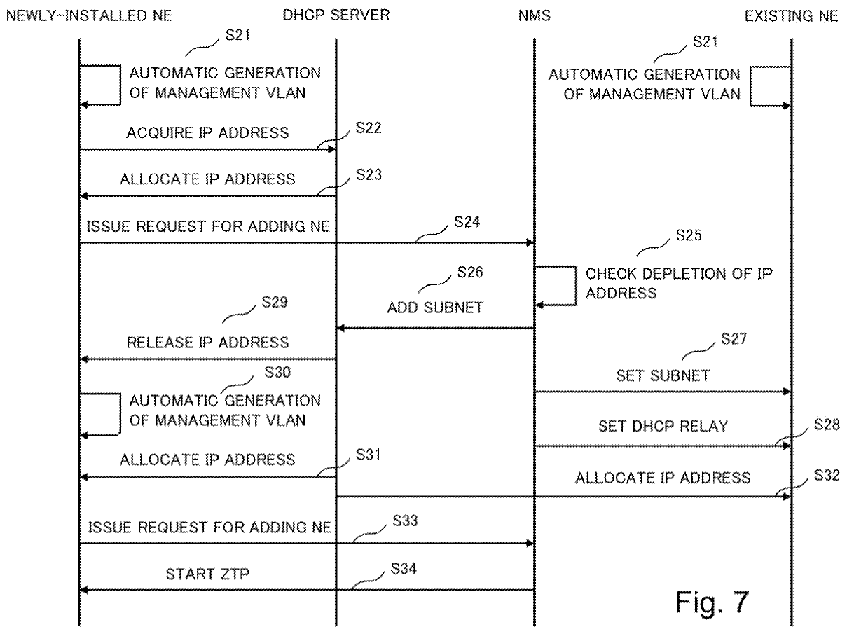

Next, with reference to relevant drawings, an operation of the communication system according to the present example embodiment is described. FIG. 3 is a flowchart for illustrating automatic allocation processing for an IP address. FIG. 4 is a flowchart for illustrating automatic setting processing for a management VLAN. FIG. 7 is a sequence chart for illustrating a processing sequence among a newly-installed NE, a DHCP server, an NMS, and an existing NE.

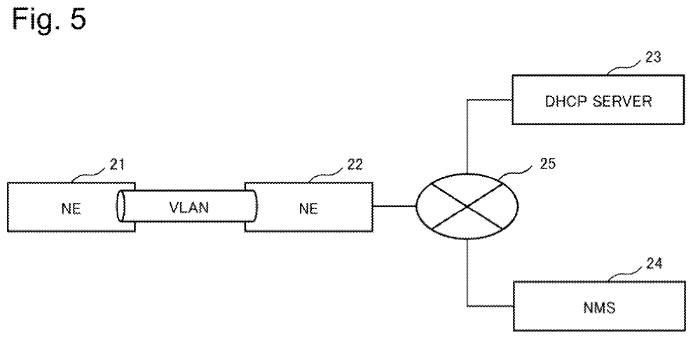

FIG. 5 is a configuration diagram for illustrating work for installing a newly-installed NE for an existing NE and setting a management VLAN. In FIG. 5, it is assumed that as one example of an existing NE, an NE 22 is registered in an NMS 24 and is already operated, an NE 21 is newly installed by a construction worker as one example of a newly-installed NE, and the NE 21 is connected to the NE 22 as an opposite destination via a wired cable or radio connection.

The NE 21 and the NE 22 in FIG. 5 activate, when a link up state is detected (S11 in FIG. 4), a management VLAN for the communication unit 11 that detects link up (S12 in FIG. 4) and automatically generates a management VLAN (S21 in FIG. 7). In the management VLAN, as a VLAN ID used for a management VLAN, a previously-determined value is used and the VLAN ID is used in a communication unit 11 of all NEs (the NE 21 and the NE 22).

After management VLAN connection (S1 in FIG. 3), the NE 21 transmits a DHCP discover message and searches a DHCP server. The NE 21 discovers a DHCP server 23 and thereafter requests the DHCP server 23 to deliver an IP address for acquiring an IP address (S22 in FIG. 7). The DHCP server 23 allocates an IP address to the NE 21 (S2 in FIGS. 3 and S23 in FIG. 7), and the NE 21 receives the IP address from the DHCP server 23 and thereafter sets the received IP address for the communication unit 11.

After setting of the IP address, for an NE addition request (S24 in FIG. 7), the NE 21 transmits an LLDP message. The NE 22 receives the LLDP message from the NE 21, and thereafter extracts, by an adjacency detection unit 7, information such as an IP address from the LLDP message and notifies the NMS 24 of the extracted information. An NE management unit 13 of the NMS 24 receives adjacent information, and thereafter makes connection to the NE 21, collects information necessary for monitoring from the NE 21, and completes NE registration (S3 in FIG. 3).

An IP address management unit 14 of the NMS 24 confirms a deliverable IP address (S25 in FIG. 7). When the number of deliverable IP addresses is less than a (any value) with respect to the number of NEs (YES in S4 of FIG. 3), it is determined that an IP address may be depleted and a new network address is added to the DHCP server 23 (S5 in FIG. 3). Deliverable network addresses are previously registered in the NMS 24 and a new network address is used from among the registered network addresses. When the number of deliverable IP addresses is equal to or more than α with respect to the number of NEs (NO in S4 of FIG. 3), IP address automatic allocation is terminated.

Next, the NMS 24 instructs the DHCP server 23 to add a subnet

(S26 in FIG. 7) and sets the subnet for the NE 22 being an existing NE (S27 in FIG. 7). An NE management unit 13 of the NMS 24 modifies, for the NE 22, an IP address of the communication unit 11 connected to the NE 21 and activates, for a DHCP function unit 5, a DHCP relay agent. In other words, for an NE (the NE 22 being an existing NE) before the NE 21 being a newly-installed NE, a DHCP relay and a new IP address are set (S6 in FIGS. 5 and S28 in FIG. 7). For a new IP address, a minimum address in a network address set in a prior process (S5 in FIG. 3) is used.

Next, the NE management unit 13 of the NMS 24 deletes the NE 21 (added in S3 of FIG. 3) and requests the NE 21 to forcedly release an IP address (S7 in FIGS. 3 and S29 in FIG. 7). The NE 21 releases the IP address, and thereafter the NE 21 being a newly-installed NE is allocated with a new IP address from the DHCP server 23 (S7 in FIG. 3). The DHCP server 23 allocates an IP address to the NE 21 (S31 in FIG. 7) and allocates an IP address to the NE 22 (S32 in FIG. 7). The NE 21 acquires, from the DHCP server 23, the IP address of a network address band set in the prior process (S5 in FIG. 3).

Next, the NE 21 executes, based on a method similar to the prior process (S3 in FIG. 3), registration processing to the NMS 24 (S9). In other words, after an IP address allocated in S8 of FIG. 3 is set, the NE 21 transmits an LLDP message for a request for adding an NE (S33 in FIG. 7). The NE 22 receives the LLDP message from the NE 21, and thereafter extracts, by the adjacency detection unit 7, information such as an IP address from the LLDP message and notifies the NMS 24 of the extracted information. The NE management unit 13 of the NMS 24 receives adjacent information, and thereafter makes connection to the NE 21, collects information necessary for monitoring from the NE 21, and completes NE registration.

In this manner, a newly-installed NE 21 establishes a DCN with the NMS 24 and therefore starts zero touch provisioning (ZTP) (S34 in FIG. 7).

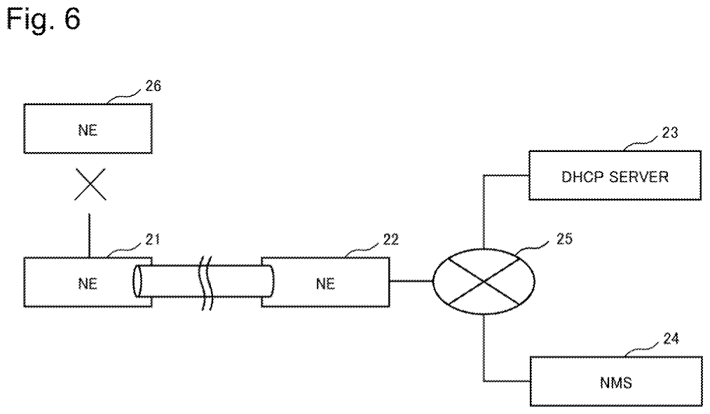

This operation is also effective for a scene, as illustrated in FIG. 6, where an NE 22 and an NE 21 are registered and operated in the NMS 24 as one example of an existing NE, an NE 26 is installed as one example of a newly-installed NE by a construction worker, and the NE 26 is connected to the NE 21 as an opposite destination via a wired cable or radio connection.

The NE 26 and the NE 21 in FIG. 6 detect a link up state, and thereby activate a management VLAN for a communication unit 11 having detected link up, and automatically generates a management VLAN (S21). In accordance with an operation illustrated in a sequence chart of FIG. 7, addition of the NE 26 to the NMS 24, allocation and division of a subnet, and reallocation of an IP address are automatically executed. The NE 26 newly installed in this manner establishes a DCN with the NMS 24 and starts zero touch provisioning (ZTP). When an NE is added in a multihop manner in this manner, the communication system according to the example embodiment of the present invention can automatically construct a DCN.

### (Advantageous Effects of the Example Embodiment)

According to the communication device and the communication system of the present example embodiment, when an NE 1 detects link up with another communication device (NE), the NE 21 activates a management VLAN, and thereby the management VLAN is set for a communication unit 11. Thereafter, via the another communication device (NE), a VLAN network for a data communication network (DCN) is constructed on an NE added in a multihop manner. According to the communication device and the communication system of the present example embodiment, work for setting a management VLAN can be automated.

According to the communication device and the communication system of the present example embodiment, a CAPEX can be reduced based on simplification of installation work. The reason is that when an NE (NE 21) is added, a DCN is automatically set and it is unnecessary to manually set a DCN, and therefore a CAPEX can be reduced.

According to the communication device and the communication system of the example embodiments of the present invention, when an NE is added in a multihop manner, addition of an added NE to the NMS 24, allocation of a subnet, and reallocation of an IP address are automatically executed, and thereby a DCN can be automatically constructed.

### [Other Example Embodiment]

As described above, while the preferred example embodiments according to the present invention have been described, the present invention is not limited to these example embodiments. There is a link aggregation configuration in which a plurality of communication ports are united and handled as a single logical communication port. Also in a link aggregation configuration, a management VLAN is set separately from traffic passing through the configuration, and thereby a DCN can be constructed.

It is also conceivable to make a configuration by using, other than a management VLAN, virtual routing and forwarding (VRF). Also in an IP virtual private network (IP-VPN) using VRF, VRF for management is set, and thereby a DCN can be set similarly to a management VLAN. In a case of VRF, VRF for management is activated for a communication port causing a DCN to pass instead of a VLAN ID, and thereby a DCN is achieved. It should be noted that various modifications may be made without departing from the scope of the invention as defined by the claims and these modifications are also included in the scope of the present invention.

The whole or part of the example embodiments disclosed above can be described as, but not limited to, the following supplementary notes.

(Supplementary note 1)

A communication device including:

a communication unit that communicates with another communication device; and

a management-virtual local area network (VLAN) management unit that activates, when a link up state with the another communication device is detected, a management VLAN and sets the management VLAN for the communication unit.

(Supplementary note 2)

The communication device according to supplementary note 1, further including:

a data communication network (DCN) communication unit to be connected to a dynamic host configuration protocol (DHCP) server that allocates an Internet protocol (IP) address; and

an Ethernet unit that manages a media access control (MAC) address of each of the communication unit and the DCN communication unit.

(Supplementary note 3)

The communication device according to supplementary note 2, wherein

the Ethernet unit further includes an adjacency detection unit that detects link up with the another communication device.

(Supplementary note 4)

The communication device according to supplementary note 2 or supplementary note 3, wherein

the management VLAN supervising unit sets the management VLAN for the communication unit, associates the communication unit with the Ethernet unit, and causes DCN data flowing in the communication unit to flow in the Ethernet unit.

(Supplementary note 5)

A communication system including:

a network management system that manages one or a plurality of communication devices;

a dynamic host configuration protocol (DHCP) server that allocates an Internet protocol (IP) address to the one or the plurality of communication devices; and

the another communication device that communicates with the communication device according to any one of supplementary note 1 to supplementary note 4, the another communication device being managed by the network management system and being allocated with an IP address by the DHCP server.

(Supplementary note 6)

The communication system according to supplementary note 5, wherein

the DHCP server allocates, when a communication device is newly installed, an IP address to the communication device and allocates a subnet to the one or the plurality of communication devices being managed by the network management system.

(Supplementary note 7)

The communication system according to supplementary note 5 or supplementary note 6, wherein

the network management system includes a network element (NE) management unit that manages the one or the plurality of communication devices and an IP address management unit that manages an IP address of the one or the plurality of communication devices, and

the IP address management unit confirms, after the newly-installed communication device is registered in the NE management unit, an IP address deliverable to the newly-installed communication device.

(Supplementary note 8)

The communication system according to supplementary note 7, wherein

the IP address management unit of the network management system confirms a possibility that an IP address is depleted, based on the number of the deliverable IP addresses and the number of one or a plurality of communication devices being managed by the NE management unit.

(Supplementary note 9)

The communication system according to supplementary note 8, wherein

the IP address management unit of the network management system adds a new network address to the DHCP server when the number of the deliverable IP addresses is less than a predetermined value with respect to the number of one or a plurality of communication devices being managed by the NE management unit.

(Supplementary note 10)

The communication system according to supplementary note 9, wherein

the NE management unit of the network management system modifies an IP address of a communication unit of the another communication device and activates a dynamic host configuration protocol (DHCP) relay agent for a DHCP function unit of the another communication device.

(Supplementary note 11)

The communication system according to supplementary note 9 or supplementary note 10, wherein

the NE management unit of the network management system deletes registration information relating to the newly-installed communication device, and issues a request for forced release of an IP address to the newly-installed communication device, and

the DHCP server allocates, after the newly-installed communication device releases an IP address in response to the forced release, a new IP address to the newly-installed communication device.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A communication device comprising:
a communication unit that communicates with another communication device; and
a management-virtual local area network (VLAN) management unit that activates, when a link up state with the another communication device is detected, a management VLAN and sets the management VLAN for the communication unit.

2. The communication device according to claim 1, further comprising:
a data communication network (DCN) communication unit to be connected to a dynamic host configuration protocol (DHCP) server that allocates an Internet protocol (IP) address; and
an Ethernet unit that manages a media access control (MAC) address of each of the communication unit and the DCN communication unit.

3. The communication device according to claim 2, wherein
the Ethernet unit further includes an adjacency detection unit that detects link up with the another communication device.

4. The communication device according to claim 2, wherein
the management VLAN supervising unit sets the management VLAN for the communication unit, associates the communication unit with the Ethernet unit, and causes DCN data flowing in the communication unit to flow in the Ethernet unit.

5. A communication system comprising:
a network management system that manages one or a plurality of communication devices;
a dynamic host configuration protocol (DHCP) server that allocates an Internet protocol (IP) address to the one or the plurality of communication devices; and
the another communication device that communicates with the communication device according to claim 1, the another communication device being managed by the network management system and being allocated with an IP address by the DHCP server.

6. The communication system according to claim 5, wherein
the DHCP server allocates, when a communication device is newly installed, an IP address to the communication device and allocates a subnet to the one or the plurality of communication devices being managed by the network management system.

7. The communication system according to claim 5, wherein
the network management system includes a network element (NE) management unit that manages the one or the plurality of communication devices, and an IP address management unit that manages an IP address of the one or the plurality of communication devices, and
the IP address management unit confirms, after the newly-installed communication device is registered in the NE management unit, an IP address deliverable to the newly-installed communication device.

8. The communication system according to claim 7, wherein
the IP address management unit of the network management system confirms a possibility that an IP address is depleted, based on a number of the deliverable IP addresses and a number of one or a plurality of communication devices being managed by the NE management unit.

9. The communication system according to claim 8, wherein
the IP address management unit of the network management system adds a new network address to the DHCP server when a number of the deliverable IP addresses is less than a predetermined value with respect to a number of one or a plurality of communication devices being managed by the NE management unit.

10. The communication system according to claim 9, wherein
the NE management unit of the network management system modifies an IP address of a communication unit of the another communication device and activates a dynamic host configuration protocol (DHCP) relay agent for a DHCP function unit of the another communication device.

11. The communication system according to claim 9, wherein
the NE management unit of the network management system deletes registration information relating to the newly-installed communication device, and issues a request for forced release of an IP address to the newly-installed communication device, and
the DHCP server allocates, after the newly-installed communication device releases an IP address in response to the forced release, a new IP address to the newly-installed communication device.
